(19) United States
(12) Patent Application Publication
(10) Pub. No.: US 2014/0257946 A1
(43) Pub. Date: Sep. 11, 2014

(54) Digital Price, Space Management, and Advertising Display

(71) Applicant: Kirk Allen High, Round Rock, TX (US)

(72) Inventor: Kirk Allen High, Round Rock, TX (US)

(73) Assignee: Smartstrips, LLC, Round Rock, TX (US)

(21) Appl. No.: 14/131,393

(22) PCT Filed: Jul. 7, 2012
(86) PCT No.: PCT/US2012/045870

§ 371 Date: Apr. 10, 2014

Related U.S. Application Data
(60) Provisional application No. 61/506,020, filed on Jul. 8, 2011.

(51) Int. Cl. G06Q 30/02

(52) U.S. Cl. CPC G06Q 30/0241
USPC 705/14.4

(57) ABSTRACT

A digital display system for displaying pricing data, product data, and advertising data on digital display strips connected to shelving in stores and adapted to interface with product placement software enabling the pricing data, product data and advertising data to be positioned & displayed on the digital display strips according to coordinates supplied by the product placement software.

### CROSS-REFERENCES TO RELATED APPLICATIONS

This application claims the priority of U.S. 61/506,020 filed on Jul. 8, 2011.

### BACKGROUND OF THE INVENTION

1. Field

The invention to be described relates to electronic display systems for use in a sales environment.

2. Description of Related Art

Electronic display systems in sales systems have been described in the prior art. There most common use is for displaying prices of merchandise on store shelves and are connected in some way to a central computer server in which pricing information is maintained in a data file. A typical display system might include a liquid crystal display (LCD) for displaying prices, but could also include LED, e-paper, or other means.

U.S. Pat. No. 6,290,128 to Goodwin describes such an electronic display system that in addition to prices displays coded information such as sales figures and inventory levels for store employees. It can also display promotional information such as whether an item is “on sale”.

Establishments such as grocery stores or pharmacies also make use of what is called “plan-o-gram” (also referred to as “modulars”) software that creates optimal product placement on store shelf locations. U.S. Pat. No. 7,699,226 describes such a software system that creates plan-o-grams and transmits them to a user interface in a pharmacy.

The embodiments to be described herein go considerably past these earlier developments and provide a sales establishment with much more functionality in electronic display systems. A system will be described that will provide not only pricing information, but an integrated solution with plan-o-gram integration and continuous advertising messages to shoppers in the sales environment.

### BRIEF SUMMARY OF THE INVENTION

The solution to address these needs includes at least a digital display strip designed to conform to the dimensions of the shelf edge and can be in various increments of length to match standard shelving and can also be affixed to the gondola in front of tag pegs. Typically shelving is in 3 and 4-foot increments. The display is designed to affix to standard shelving and can run along the shelf edge for the length of an aisle. By affixing the strips adjacent to each other the length of the aisle it will allow information to be rendered anywhere along the aisle. The display can place information anywhere along the length of the display and show digital price tags including the item price, both one and two dimensional bar codes (such as universal product (upc) code, QR codes, Aztec Codes, and similar relating to product information, coupons or advertising portals), weight, inventory count and other product information; and can display that information to locations along the display coinciding to the locations designed by product placement software. In addition, in areas not designated for price & product information, continuous advertising, cross-promotional and other messages to shoppers can be displayed.

This need is addressed by providing a digital display system for shelf space in a store including at least a digital display strip adapted to be attached to store shelving or freestanding fixtures and having a display screen for displaying pricing data, product data, and advertising data; wherein the digital display strip is adapted to interface with product placement software enabling the pricing data, product data and advertising data to be positioned & displayed on the digital display strips according to coordinates supplied by the product placement software.

The need is further addressed by providing a method for displaying pricing data, product data, and advertising on store shelves comprising the steps of providing product placement information, pricing data, product data, and advertising data to a central computer connected to local or remotely located computers at multiple stores; providing product placement information, pricing data, product data, and advertising data from said central computer to multiple local or remotely located computers at local stores; providing product placement information, pricing data, product data, and advertising data from said local or remotely located computers to multiple digital display strips in said local stores and displaying said pricing data, product data, and advertising data on said digital display strips based on said product placement information.

The need is further provided by the provision of a local or remotely located computer is in communication with the digital display strip to communicate product placement, pricing data, product data, and advertising data to said display strip; said local or remotely located computer in communication with other display strips wirelessly or wired through a local area or wide area network.

The need is further provided by provision of a central computer that interfaces with said local or remotely located computer and is in communication wirelessly or wired with said local or remotely located computer through a local or wide area network.

The need is further provided by providing databases feeding into said central computer containing product placement information, pricing data, product data, and advertising data.

The need is further provided by use of plan-o-gram or modular software to provide the product placement information.

### BRIEF DESCRIPTION OF THE FIGURES

FIG. 1 is a view of a continuous strip of the digital display.

FIG. 2 is a rendering of a possible layout of the servers in a central computer office of a sales establishment.

FIG. 3 is a rendering of one of the remote offices of the sales establishment and the local area network and it's connection to the digital display.

FIG. 4 is an alternate view of a continuous strip of the digital display.

### DETAILED DESCRIPTION OF EMBODIMENTS

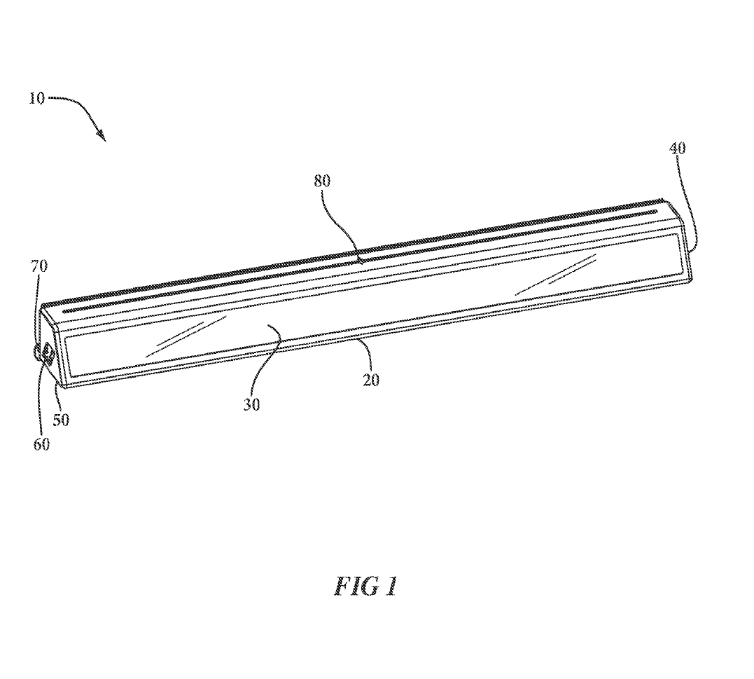

In FIG. 1 shown generally as the numeral 10 is one unit (a digital display strip) of the digital display that can be affixed to display shelving. The overall strip structure is a thin screen overlaid on the shelf face and a connector opening 60 for connection of power and/or optical connections. The screen display may be based on an LED display or an e-paper display or other display means. Optionally, the strips could be powered by a battery or sustained by remote electromagnetic recharging. Optionally, a detector 80 to indicate when an item has been removed or is out of stock can be incorporated.

The digital display strip can be adapted to interface with product placement software enabling the pricing data, product data, and advertising data to be properly positioned and displayed on the digital display strips according to coordinates supplied by the product placement software. This adaptation may be through embedded software or firmware in each strip or software residing on local store computers 220.

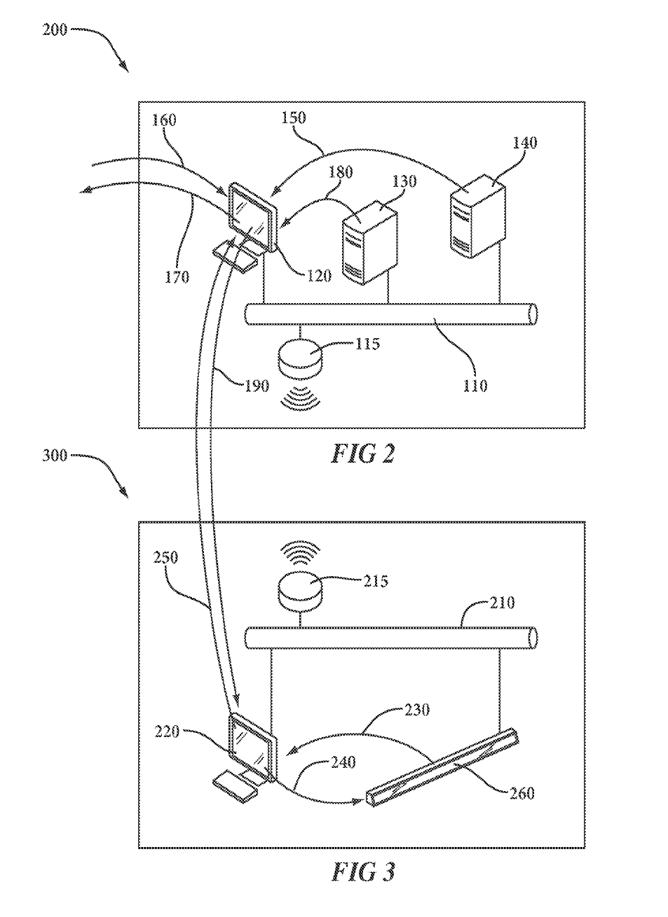

FIG. 2 and FIG. 3 (together) show the systems functionality. Shown, as the numeral 300, is a local sales establishment in which a large number of electronic displays 260 are in place attached to shelving below merchandise. In that establishment a local computer 220 is connected to those electronic display strips 260 by a store local area network (LAN) 210.

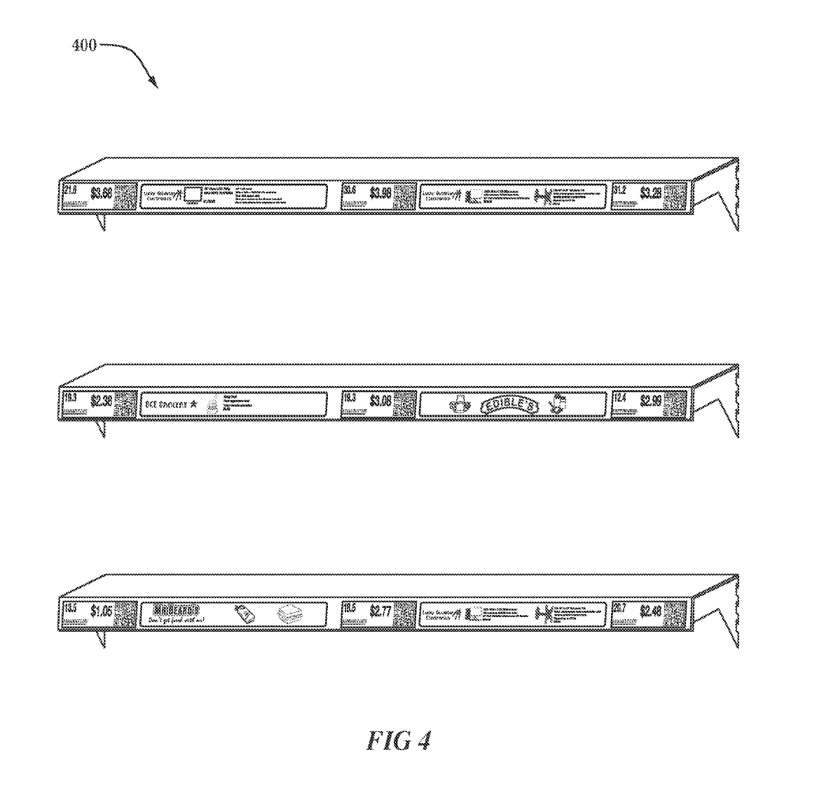

FIG. 4, represented generally by the numeral 400, demonstrates an example set of shelves using the digital display strip system. The placement of the product data, advertising data and pricing data as well as the data itself can be changed automatically from the central computer.

The numeral 200 represents a central office for a large number of sales establishments such as that of numeral 300. A central computer 120 is in communication through a central office LAN 110 that is in communication with the local store LANs 210. This linkage can be through a wide area network (WAN) and a private or virtual private network (VPN) (115,215). Central computer 120 is also linked with databases of point of sale (POS) and pricing data 130 and with the organization's product placement or plan-o-gram (modular) database 140.

Central computer 120 receives pricing data 180, product placement or plan-o-gram information and other product data 150, and also receives advertising data 160 from an advertisement server that might be located externally or might be in the central office. Through these various networks central computer 120 can then send 190 pricing data, product placement or plan-o-gram (modular) information, product data and advertising data to local store computers 220, which then can transfer that data 240 to the numerous digital display strips 260. The product placement data is used to properly place the appropriate pricing information directly under the correct product. Digital display strips 260 may be equipped with embedded capability to receive, decode, and acknowledge the information from the product placement plan-o-gram information in order to properly place the pricing, product, and advertising data. This capability may be available from firmware or stored software instructions. Alternately software from local store computers 220 might be programmed to accept coordinates from product placement software and drive placement on the digital display strips 260. The digital display strips 260 are thus adapted to interface with the product placement or plan-o-gram software enabling pricing, product, and advertising data to be positioned and displayed on the digital display strips according to product placement or plan-o-gram (modular) coordinates. Product data may comprise one or two dimensional bar codes, perpetual inventory counts, and point of purchase information. The remaining space on display strips 260 is then available for placing of advertising, cross promotion, and other messages. These other messages might include social media streams and connections. Pricing data comprises current prices as well as coupon information. The pricing data and advertising data can also be programmed to change according to the time of day.

Returning to numeral 300, digital display strips 260 can also have a detector (80 in FIG. 1) that senses the removal of items and sends out-of-stock data 230 back to local store computer 220. Local computer 220 then can send out-of-stock data 250 back to central computer 120, which can send out-of-stock notifications 170 to vendors.

The Central computer may communicate via a TCP/IP data network to receive updates to pricing from the store's pricing database 130 and to receive updates to product placement plan-o-gram information from the store's product placement plan-o-gram (modular) software. The central computer also receives updates to advertisements from an advertisement server. The central computer then communicates these updates to the local store computer via a data network (TCP/IP via private WAN connection or VPN tunnel). The local store computer 220 connects to digital display strips 260 throughout the store via a wired or wireless data network to communicate digital price tags, plan-o-gram and advertisements, digital display units 260 communicate out-of-stock items to the local computer via the network. The local computer then sends the out-of-stock info to the central computer where that info is sent to management and/or vendors.

Central computer 120 sends changes to the local store's product placement or plan-o-gram information. Product placement updates are sent to the local store computer 220. The local store computer 220 places desired items of the new plan-o-gram on the digital display. The local store computer 220 can be used to do an override of product placement plan-o-gram information for that store. The override is sent back to the central computer and may need to be approved by a user in the central office. If a change is received by the local store computer that conflicts with a previous override, then a user may be required to accept or deny the new product placement plan from the central computer.

The central computer 120 accesses pricing information from the store's POS software or price database. This connection will likely be a SQL (Structured Query Language), ODBC (Open Database Connectivity) or other similar connection. New digital price tags are sent to the local store computer 220. Local store computer 220 displays the new digital price tags on the digital display strips 260. The local store computer 220 can be used to do an override of digital price tags for that store. The override is sent back to the central computer and may need to be approved by a user in the central office. If the local store computer receives a change that conflicts with a previous override then a user may be required to accept or deny the new and conflicting prices from the central computer.

The central computer 120 will download new advertisements from the advertising server. Once downloaded, the central computer can send the advertisements to the local store computers. The local store computer then sends the advertisements to the digital displays within that store for display. Optionally, the local store computer communicates with the digital display strips 260 to read the out of stock items. The out-of-stock info is communicated from the local store computer to the central computer. The central computer then sends notifications of out-of-stock items to management and/or vendors.

The pricing data, product data, and advertising data available to the digital display strips on store shelving may be accessible by a wired or wireless network to other store devices, which may include mobile devices or in-store kiosks.

Although certain embodiments of the present invention and their advantages have been described herein in detail, it should be understood that various changes, substitutions and alterations can be made without departing from the spirit and scope of the invention as defined by the appended claims. Moreover, the scope of the present invention is not intended to be limited to the particular embodiments of the processes, machines, manufactures, means, methods, and steps described herein. As a person of ordinary skill in the art will readily appreciate from this disclosure, other processes, machines, manufactures, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufactures, means, methods, or steps.

1. A digital display system for shelf space in a store comprising:
a. a digital display strip adapted to be attached to store shelving or freestanding fixtures and having a display screen for displaying pricing data, product data, and advertising data;
b. wherein said digital display strip is adapted to interface with product placement software enabling said pricing data, product data and advertising data to be positioned & displayed on the digital display strips according to coordinates supplied by said product placement software.

2. The digital display system for shelf space in a store of claim 1 wherein a local or remotely located computer is in communication with said digital display strip to communicate product placement, pricing data, product data, and advertising data to said display strip; said local or remotely located computer in communication with other display strips wirelessly or wired through a local area or wide area network.

3. The digital display system for shelf space in a store of claim 2 wherein there is a central computer that interfaces with said local or remotely located computer and is in communication wirelessly or wired with said local or remotely located computer through a local or wide area network.

4. The digital display system for shelf space in a store of claim 3 wherein there are databases feeding into said central computer containing product placement information, pricing data, product data, and advertising data.

5. The digital display system for shelf space in a store of claim 1 wherein said digital display strips can span the length of an aisle allowing displayed data to be placed anywhere along the shelf edge.

6. The digital display system for shelf space in a store of claim 1 wherein said product information comprises plan-o-gram or modular data and is used to place desired information along the length of the shelf.

7. The digital display system for shelf space in a store of claim 1 wherein said product data comprises one or two-dimensional bar codes.

8. The digital display system for shelf space in a store of claim 1 wherein said product data comprises perpetual inventory counts.

9. The digital display system for shelf space in a store of claim 1 wherein said product data comprises point of purchase data.

10. The digital display system for shelf space in a store of claim 1 wherein said pricing data comprises current prices.

11. The digital display system for shelf space in a store of claim 1 wherein said pricing data comprises coupon data.

12. The digital display system for shelf space in a store of claim 1 wherein said advertising data comprises social media streams and connections.

13. The digital display system for shelf space in a store of claim 1 wherein said advertising data comprises cross promotions with other merchandise.

14. The digital display system for shelf space of claim 1 wherein said display screen is an e-paper display screen.

15. The digital display system for shelf space of claim 1 wherein said display screen is an LED display screen.

16. A method for displaying pricing data, product data, and advertising on store shelves comprising the steps of:
a. providing product placement information, pricing data, product data, and advertising data to a central computer connected to local or remotely located computers at multiple stores;
b. providing product placement information, pricing data, product data, and advertising data from said central computer to multiple local or remotely located computers at local stores;
c. providing product placement information, pricing data, product data, and advertising data from said local or remotely located computers to multiple digital display strips in said local stores; and
d. displaying said pricing data, product data, and advertising data on said digital display strips based on said product placement information.

17. The method for displaying pricing data, product data, and advertising data on store shelves of claim 16 wherein said pricing data can be programmed to change according to the time of day.

18. The method for displaying pricing data, product data, and advertising data on store shelves of claim 16 wherein said advertising data could be programmed to change according to the time of day.

19. The method for displaying pricing data, product data, and advertising data on store shelves of claim 16 wherein said data could be accessed by other store devices.

20. The method for displaying pricing data, product data, and advertising data on store shelves of claim 19 wherein said other store devices comprise in-store kiosks.
